(19) United States
(12) Patent Application Publication
(10) Pub. No.: US 2004/0040188 A1
(43) Pub. Date: Mar. 4, 2004

(54) Calendar

(76) Inventors: Masao Yamamoto, Tokyo (JP); Masashi Takayama, Osaka (JP)

Correspondence Address: ISRAEL GOPSTEIN, Esq., P.O. BOX 9303, SILVER SPRING, MD, 20916-9303, US

(21) Appl. No.: 10/652,335

(22) Filed: Sep. 2, 2003

(30) Foreign Application Priority Data
Sep. 4, 2002 (JP) 2002-259151

(51) Int. Cl. G09D 3/02

(52) U.S. Cl. 40/122

(57) ABSTRACT

A calendar including a daily designation table and a space for designating the distributor of the calendar as well as a space for the advertisement of the sponsor, wherein: the designations on the part of the day such as “morning”, “midday”, and “evening” for which the medicine is to be taken are provided in each date section of the daily designation table, and wherein a medicine pouch is able to attach removably on one of the designations on the part of the day.

### BACKGROUND OF THE INVENTION

1. Technical Field

The present invention relates to a truly new calendar.

2. Description of the prior art

Calendars are conventionally distributed among customers or consumers for the purpose of advertising a company producing the calendar or products or services to be obtained from the company. Thus the cost for producing the calendars are burdened on the company, and the cost can be estimated to the amount not to be ignored.

The conventional calendars are merely the designation of the seven days of the weeks of the month.

Accordingly, the object of the present invention is to provide a calendar adapted to be used for advertising not only the distributor of the calendar but also the sponsor company and products or services to be obtained from the company. Thus, cost for producing the calendar can be covered by advertising revenue from the sponsor company.

Another object of the present invention is to provide a calendar including a daily designation table wherein the designations on the part of the day for which the medicine is to be taken are provided in each date section, and wherein a medicine pouch or an administration instructing tag is able to attach removably to the intended one of the designations on the part of the day in order not to lose the timing for taking the medicine. The displacement of the medicine pouch or the tag can be made easily after taken the medicine properly to the next designation of the part of the day.

### SUMMARY OF THE INVENTION

In order to establish the object of the present invention, a calendar in accordance with claim 1, is a calendar including a daily designation table and a space for designating the distributor of the calendar as well as a space for the advertisement of the sponsor.

The calendar for administrating medicine in accordance with claim 2, is the calendar according to claim 1, wherein; the designations on the part of the day such as “morning”, “midday”, and “evening” for which the medicine is to be taken are provided in each date section of the daily designation table.

The calendar for administrating medicine in accordance with claim 3 is the calendar according to claim 2, wherein; a medicine pouch is able to attach removably on one of the designations on the part of the day.

The calendar for administrating medicine in accordance with claim 4 is the calendar according to claim 2, wherein; a medicine pouch is adapted to be hung on the calendar by a tag including a head and a hook connected by a neck of reduced width, wherein the tag is inserted through an opening formed through the upper portion of a medicine pouch, and then the head of the tag is inserted with the pouch into the intended one of engaging openings provided through the portions corresponding respectively to each parts of the day so as to engage the head with the back side of the sheet of the calendar.

The calendar for administrating medicine in accordance with claim 5 is the calendar according to claim 4, wherein; the tag is made of a material of slight elasticity, and the breadth of the head is larger than the diameter of the engaging opening, so that the head is urged to be deformed to reduce the breadth thereof to the lateral width of the engaging opening upon inserted into the engaging opening and then recovered elastically to its original shape on the back side of the sheet and engaged with the back side.

The calendar for administrating medicine in accordance with claim 6 is the calendar according to claim 4, wherein; the respective date section of the calendar is provided crosswise with the designations on the part of the day such as “morning”, “midday”, and “evening” for which the medicine is to be taken, and laterally aligned engaging openings are also provided on the portions corresponding to the parts of the day, the engaging openings of each day are communicated with each other through a slit or communicating portion.

The calendar for administrating medicine in accordance with claim 7 is the calendar according to claim 2, wherein; an administration instructing tag is able to attach removably on one of the designations on the part of the day for indicating the timing for taking the medicine.

The calendar for administrating medicine in accordance with claim 8 is the calendar according to claim 7, wherein; the administration instructing tag is able to attach removably by an adhesive mass good at its releasability.

The calendar for administrating medicine in accordance with claim 9 is the calendar according to claim 2, wherein; the administration instructing tag including a hook or a head and a body connected by a neck of reduced width is adapted to be hung on the calendar, wherein the head of the tag is inserted through an opening formed through the intended one of engaging openings provided through the portions corresponding respectively to each parts of the day so as to engage the head with the back side of the sheet of the calendar.

### BRIEF DESCRIPTION OF THE DRAWINGS

Further feature of the present invention will become apparent to those skilled in the art to which the present invention relates from reading the following specification with reference to the accompanying drawings, in which:

FIG. 1(a) is a plan view showing a calendar of the present invention;

FIG. 1(b) is an enlarged plan view showing a calendar of the present invention;

FIG. 2 is a plan view showing a tag;

FIG. 3 is an enlarged plan view showing an engaging opening;

FIG. 4 is a plan view showing a calendar of another embodiment of the present invention;

FIG. 5 is an enlarged plan view showing engaging openings;

FIG. 6 is a perspective view showing a medicine pouch of another embodiment;

FIG. 7 is a plan view showing an example of the administration instructing tag; and

FIG. 8 is a plan view showing another example of the administration instructing tag.

### DETAILED DESCRIPTION OF THE PRESENT INVENTION

The preferred embodiments in accordance with the present invention will now be described with reference to the attached drawings.

The calendar of the present invention is adapted to be used for advertising not only the distributor of the calendar, i.e. the one who presents the calendar but also the sponsor company or products or services to be obtained from the sponsor by indicating or illustrating the information thereof on one or more spaces prepared on the calendar. Thus the advertising revenue can be expected to be obtained from the sponsor company. In other words, the calendar of the present invention is useful as a patent on the business model.

The daily designation table of the calendar in accordance with the present invention is adapted to be served not merely as the designation of seven days of weeks of a month but also as the designation of the part of the day in order not to lose the timing for taking the medicine.

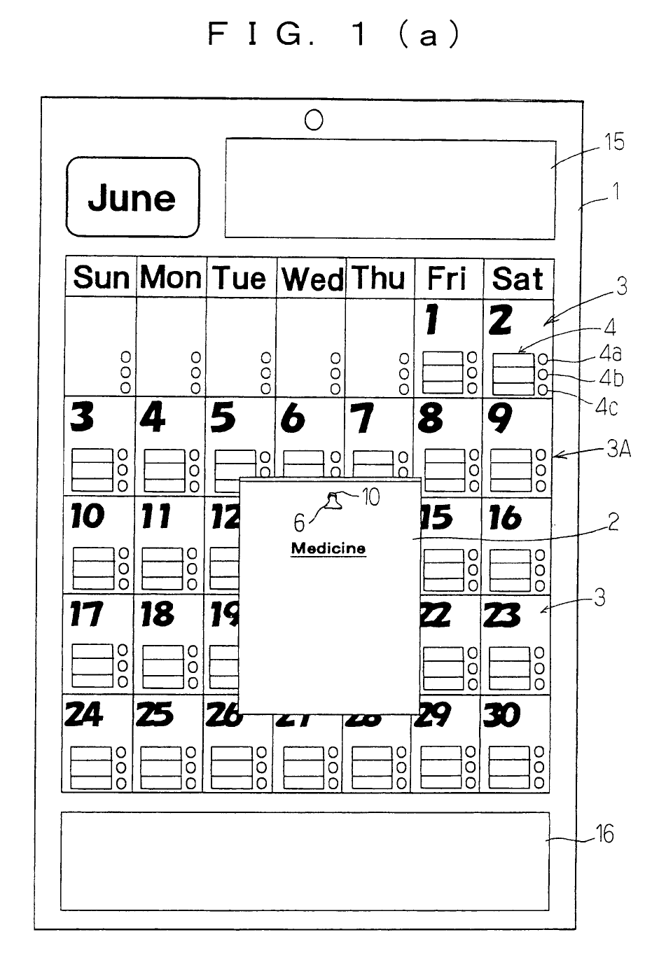

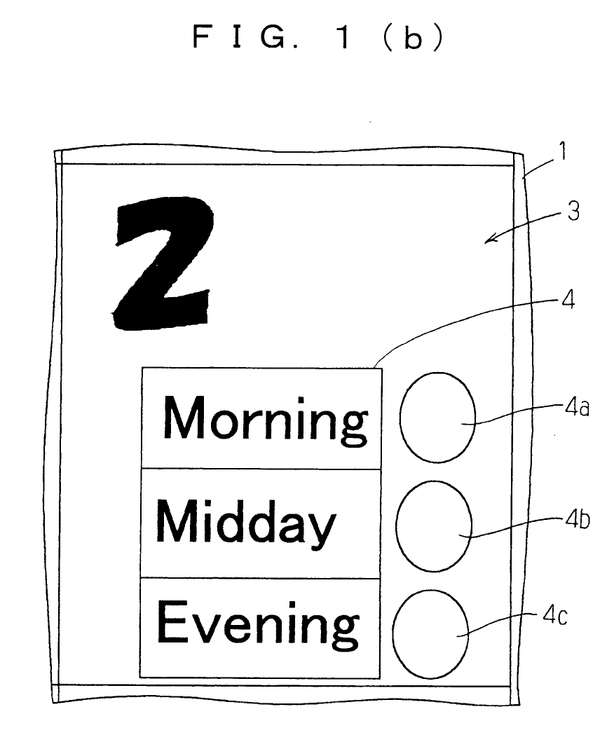

The calendar of the present invention includes not only daily designation table 3A of a certain month as shown in FIGS. 1(a) and 1(b) but also a space 16 for designating the distributor of the calendar as well as a space 15 for designating the information on the sponsor.

The information on the goods or services to be provided by medical service concerned can be printed on the space 15 for the sponsor such as pharmaceutical companies, manufacturers of medical appliances, makers of pharmaceutical foods, makers of medicare appliances, or medicare service providers. Whereas information such as the name, address, and telephone number of the distributor such as pharmacies, drugstores, hospitals distributing the calendar together with drugs as prescribed can be printed on the space 16 for the distributor. Thus the distributors or producers of the calendar may gain the advertising revenue from the sponsor company.

Each date section 3 of the daily designation table 3A of the calendar subdivided by frames also has designations 4 such as “morning”, “midday”, and “evening” for which the medicine is to be taken. Further, oblong engaging openings 4a, 4b, and 4c corresponding at their position to each designation of the part of the day respectively are provided through the sheet. A medicine pouch 2 is adapted to be hung on the opening by means of a tag 6.

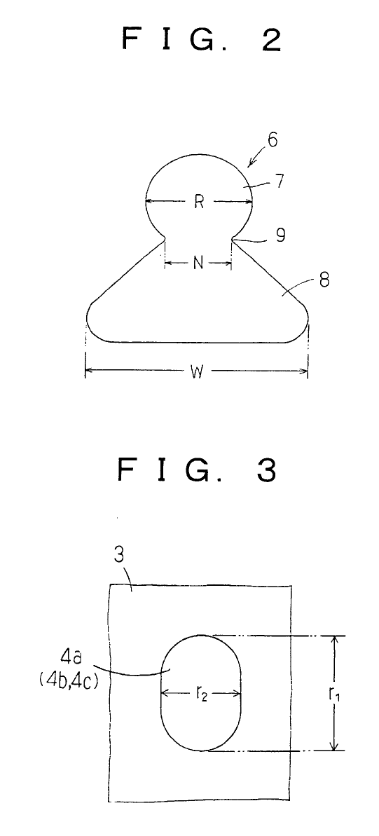

The tag 6 has as shown in FIG. 2 a substantially circular head 7 and a substantially equilateral triangle shoulder 8 connected to the head through a neck 9 of the reduced width. The tag is made preferably of a thin paperboard or a sheet of synthetic resin. Upon employing the tag 6, the head 7 is inserted through an opening 10 provided through the upper marginal portion of the medicine pouch 2 with engaging the shoulder 8 of the tag with the opening 10, and into one of the engaging openings so as to position the head opposite to the back side of the sheet. Thus, the medicine pouch 2 can be hanged by means of the tag.

The dimensional relation between each of the engaging openings 4a, 4b, and 4c and the tag 6 will now be described.

The head 7 of the tag 6 is adapted to be inserted into one of the engaging openings and then engaged with the back side of the sheet of the calendar. In this connection, the breadth (R) of the head 7 is larger than the width (r₂) of the engaging opening along the minor axis or the lateral width, and smaller than the width (r₁) of the engaging opening along the major axis or the longitudinal width, and the width (N) of the neck 9 is smaller than the lateral width (r₂).

Thus the relationship as expressed below can be obtained between the breadth (R) of the head 7, the lateral width (r₂) and the longitudinal width (r₁) of the engaging openings 4a, 4b, 4c, and the width (N) of the neck 9.

r₁≧R>r₂>N

The breadth (W) of the shoulder 8 is larger than the diameter of the opening 10 provided through the medicine pouch 2, and the breadth (R) of the head 7 is smaller than the diameter of the opening 10.

An example of the method for attaching the medicine pouch 2 to the calendar of the structure as mentioned above will now be described.

At first the head 7 of the tag 6 is inserted into the opening 10 formed through the upper marginal portion of the medicine pouch 2 with aligning the breadth of the head with the major axis of the engaging opening, and then the head 7 is inserted into the desired one of the engaging openings 4a, 4b, 4c so as to position the head opposite to the back side of the sheet of the calendar.

Upon the neck 9 reached the position of the engaging opening, the tag 6 is rotated around 90°.

The head 7 is then engaged with the back side of the sheet of the calendar since the breadth (R) of the head is larger than the lateral width of the engaging opening 4a, 4b, 4c. Thus the medicine pouch 2 is hanged stably by resting the marginal portion around the opening 10 on the left and right upper edges of the shoulder 8.

When it is intended to take the pouch out, it can be achieved by rotating the tag around 90° to align the breadth of the head with the major axis of the engaging opening, and pull it out.

Although in the above mentioned embodiment the engaging openings are of oblong shape larger in their vertical dimension, engaging openings of circular configuration may also be adopted. In such a case, the tag 6 may preferably be made of elastic material for example paperboard or sheet of synthetic resin so as to enable the head 7 to deform or reduce the breadth thereof upon inserted into the engaging opening 4a, 4b, 4c. Then the head may recover its original breadth, and engage with the back side of the sheet. Further the tag may preferably be formed of an material of hardly tear out.

An illustrative example of the method for utilizing the calendar of the present invention of the structure as mentioned above will now be described.

The medicine pouch 2 delivered from hospital or dispensary is attached to one of the engaging openings corresponding to the designated part of the day on which the first dosage is to be taken. On the first dosage, the tag 6 is removed from the engaging opening, one dose of medicine is taken, and then the medicine pouch is attached to the engaging portion corresponding to the next designated part of the day.

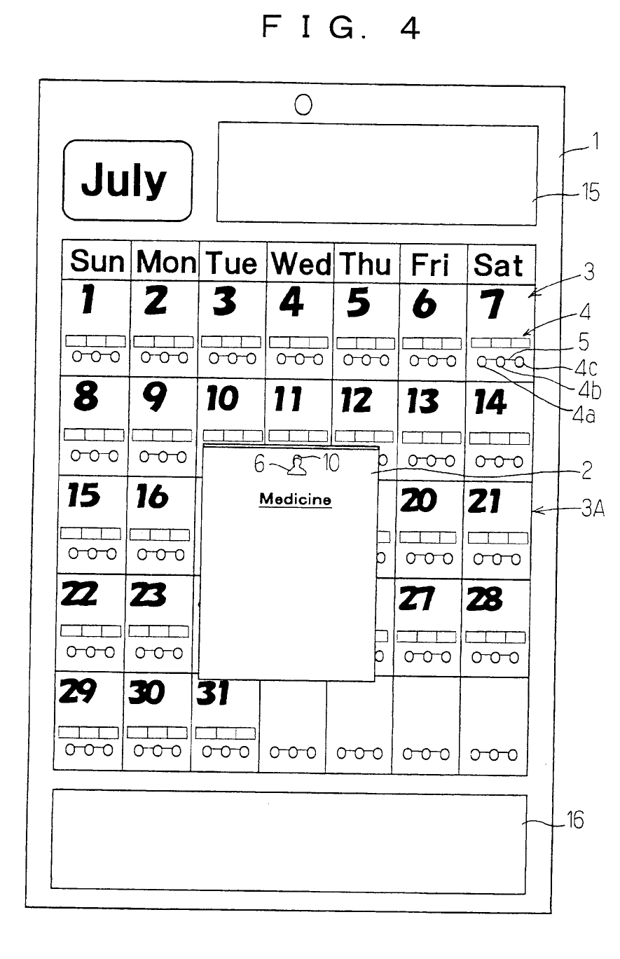

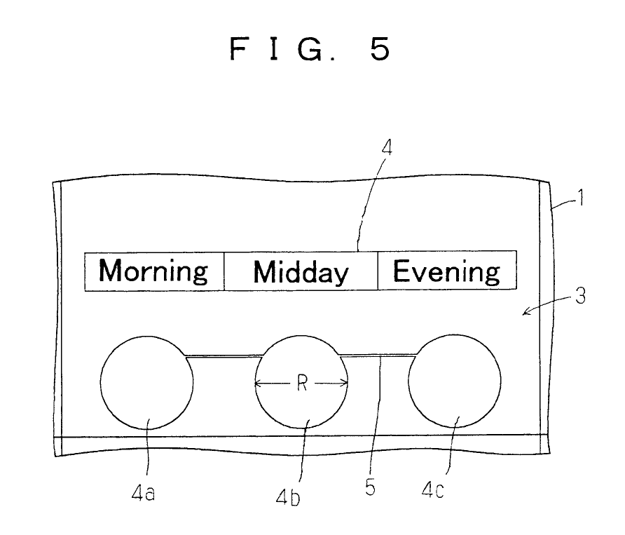

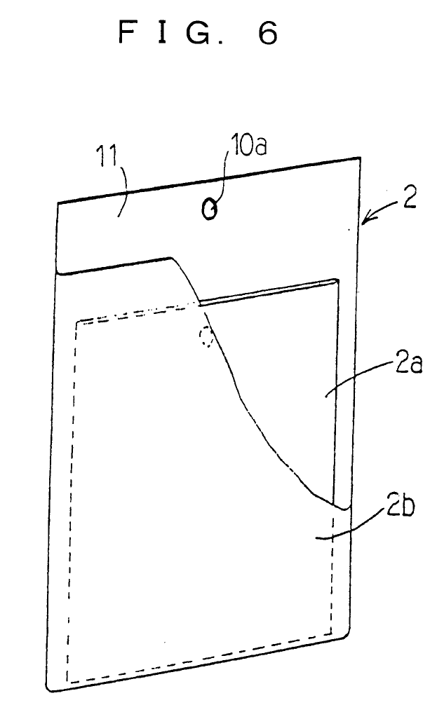

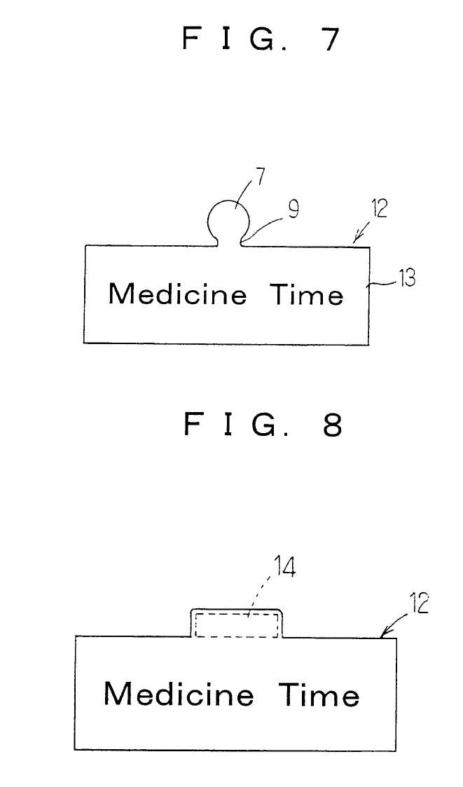

Another embodiment of the present invention will now be described with reference to FIGS. 4 and 5.

The calendar 1 of the present embodiment also includes a daily designation table 3A and spaces 15 and 16 for designating the distributor as well as the sponsor as shown in FIG. 4.

Each date section 3 of the daily designation table 3A of the calendar subdivided by frames also has designations 4 such as “morning”, “midday”, and “evening” for which the medicine is to be taken. Further, engaging openings 4a, 4b, and 4c corresponding to each designation of the part of the day respectively are provided through the sheet. A medicine pouch 2 is adapted to be hang on the opening by means of a tag 6.

The engaging openings 4a, 4b, and 4c corresponding respectively to each designation of the part of the day are as shown enlarged in FIG. 7 communicated with each other through a slit or a communicating portion 5. The communicating portion 5 can communicate the engaging openings 4a, 4b, and 4c of certain one day with each other, the engaging openings of few days, or those of one week.

A pouch 2a delivered from hospital or dispensary accommodating prescribed medicine can be used as it is. In some cases, a larger medicine pouch 2b of plastic film can be used as the medicine pouch 2 accommodating the medicine pouch 2a. The pouch includes a flap 11 at the upper end portion of the backside sheet of the pouch and an opening 10a provided through the flap for passing the head of the tag.

The breadth (R) of the head 7 is larger than the lateral width (r) of the engaging opening, the width (N) of the neck 9 is smaller than both of the lateral width (r) of the engaging opening and the lateral width of the opening 10a, and the breadth (W) of the shoulder 8 is larger than the lateral width of the opening 10a, so that the head 7 of the tag 6 can be inserted into the engaging opening 4a, 4b, 4c and then engaged with the sheet of the calendar.

The method for using the above described calendar for administrating medicine will now be described.

After inserting the head 7 of the tag 6 through the opening of the medicine pouch, the same head 7 is inserted through the communicating portion 5 connecting the opening 4a for dosing after breakfast and the opening 4b for dosing after lunch, and then the head is displaced to the opening 4a and drop it into the opening 4a to attach the medicine pouch at the opening 4a.

Upon taking the medicine after breakfast, the tag is pulled up to the upper portion of the opening 4a and displaced it along the communicating portion 5 to the opening 4b for dosing after lunch, and then drop it into the opening 4b. Thus the medicine pouch is attached at the opening 4b.

The similar sequence will be taken after lunch to displace the tag though the communicating portion 5 into the opening 4c. The medicine pouch can thus be attached at the position for dosing after evening meal.

As can be seen from the above, the cumbersome operation of previously described embodiment that the removing and attaching of the medicine pouch are to be repeated every time when the one dose of medicine had taken can be avoided in the present embodiment, once the medicine pouch is attached to the engaging opening 4a.

Upon taking the medicine after evening meal, the tag is removed from the engaging opening 4c for dosing after evening meal and then attached to the opening 4a for dosing after breakfast provided through the section of the next day.

Although in the above mentioned embodiments the medicine pouch 2 is adapted to be hung directly on the calendar 1, a card having such a designation that “medicine time” as shown in FIG. 9 or an administration instructing label 12 of tag type may also be attached to the calendar 1.

The administration instructing tag 12 also has a head 7 substantially the same as that of the above mentioned tag 6, a narrow neck 9 positioned between the head and the body 13 of the tag. The dimensional relation and the manner of engagement with the engaging openings 4a, 4b, 4c are substantially the same as that of the tag. The head 7 is adapted to be hang on the engagement opening of the required part of the day of the calendar.

In this embodiment, it must be required to confirm the instructions found on the administration instructing tag applied on the intended part of the day, pick the medicine out of the pouch to take it, and then displace the tag to the next part of the day.

Further, the administration instructing tag may optionally be provided on its back side along the upper marginal portion with the adhesive 14 as shown in FIG. 10 rather than the head and the neck. In such a case, the tag can be attached through the adhesive 14 on the required spot on the day. The preferred material for the adhesive is, for example, an acrylic adhesive mass good at its releasability, i.e. the peeling off and the applying on of it can be effected repeatedly.

In this embodiment, it must be required to confirm the instructions found on the administration instructing tag applied onto the intended part of the day, pick the medicine out of the pouch and take it, and then displace the tag to the next part of the day.

The tag can be applied on the required part 4 of the day of the calendar so that no engaging openings are required to make through the designate parts 4 of the day of the calendar.

Although in the above mentioned embodiments the calendar of each month is provided on one sheet respectively, the calendar of the one and the next months can be provided on both of the front and back sides of the sheet. In this case, the engaging openings of the front side must be common with those of the back side, so that the positioning of the engaging openings and the alignment of the daily designation table of the one month with that of the next month should be assured.

The calendar of the present invention can be used for instructing the timing of taking medicines of oral administration as well as medicines to be applied externally such as collyrium and liniment.

The calendar of the present invention can be used for advertising the goods or products of the sponsor cooperating with producing the calendar, since the calendar includes a space for designating the distributor of the calendar as well as a space for designating the information on the goods or products of the sponsor. Thus, the advertising revenue can be expected to be obtained from the sponsor company. In other words, the calendar of the present invention is useful as a patent on the business model.

The calendar of the present invention on the daily designation table of which the medicine pouch and the administration instructing tag can be applied will indicate clearly the designated part of the day for which the medicine is to be taken. The medicine pouch and the administration instructing tag hung on the calendar will leap to the eyes. This will lead to take the medicine as prescribed.

The calendar of the present invention can be used as the calendar for administrating medicine. The calendar for the guiding the manner for taking the medicine will bring the great advantages on the patients as well as on the hospitals or the dispensary since the manner for taking medicine can be guided upon distributing the calendar free of charge. Further, the advertisement on the products or the services to be provided by the sponsor of the calendar can be demonstrated on the one who taking the medicine or the patients so that the substantial advertising effect sufficient for the advertising revenue can be brought on the patients.

While particular embodiments of the present invention have been illustrated and described, it should be obvious to those skilled in the art that various changes and modifications can be made without departing from the spirit and scope of the invention.

What is claimed is:

1. A calendar including a daily designation table and a space for designating the distributor of the calendar as well as a space for the advertisement of the sponsor.

2. The calendar according to claim 1, wherein:
designations on the part of the day such as “morning”, “midday”, and “evening” for which the medicine is to be taken are provided in each date section of the daily designation table.

3. The calendar according to claim 2, wherein:
a medicine pouch is able to attach removably on one of the designations on the part of the day.

4. The calendar according to claim 2, wherein:
a medicine pouch is adapted to be hung on the calendar by a tag including a head and a hook connected by a neck of reduced width, wherein the tag is inserted through an opening formed through the upper portion of a medicine pouch, and then the head of the tag is inserted with the pouch into the intended one of engaging openings provided through the portions corresponding respectively to each parts of the day so as to engage the head with the back side of the sheet of the calendar.

5. The calendar according to claim 4, wherein:
the tag is made of a material of slight elasticity, and the breadth of the head is larger than the diameter of the engaging opening, so that the head is urged to be deformed to reduce the breadth thereof to the lateral width of the engaging opening upon inserted into the engaging opening and then recovered elastically to its original shape on the back side of the sheet and engaged with the back side.

6. The calendar according to claim 4, wherein:
respective date section of the calendar is provided crosswise with the designations of the part of the day such as “morning”, “midday”, and “evening” for which the medicine is to be taken, and laterally aligned engaging openings are also provided on the portions corresponding to the parts of the day, the engaging openings of each day are communicated with each other through a slit or communicating portion.

7. The calendar according to claim 2, wherein:
an administration instructing tag is able to attach removably on one of the designations on the part of the day for indicating the timing for taking the medicine.

8. The calendar according to claim 7, wherein:
the administration instructing tag is able to attach removably by an adhesive mass good at its releasability.

9. The calendar according to claim 2, wherein:
the administration instructing tag including a hook or a head and a body connected by a neck of reduced width is adapted to be hung on the calendar, wherein the head of the tag is inserted through an opening formed through the intended one of engaging openings provided through the portions corresponding respectively to each parts of the day so as to engage the head with the back side of the sheet of the calendar.
